(19) United States
(12) Patent Application Publication
(10) Pub. No.: US 2006/0215754 A1
(43) Pub. Date: Sep. 28, 2006

(54) Method and apparatus for performing video decoding in a multi-thread environment

(75) Inventors: Mark Buxton, Chandler, AZ (US); Tom Craver, Chandler, AZ (US); Peter Nee, Redmond, WA (US)

Correspondence Address: Lawrence Cho;Attorney at Law, c/o PortfolioIP, P.O. Box 52050, Minneapolis, MN, 55402, US

(73) Assignee: Intel Corporation

(21) Appl. No.: 11/088,366

(22) Filed: Mar. 24, 2005

(51) Int. Cl. H04N 7/12; H04N 11/04; H04N 11/02; H04B 1/66

(52) U.S. Cl. 375/240.12; 375/240.25; 375/240.24

(57) ABSTRACT

A method for performing video decoding includes executing a functionally decomposed video decoding procedure on a plurality of threads. Other embodiments are described and claimed.

### FIELD

Embodiments of the present invention relate to video decoding. More specifically, embodiments of the present invention relate to a method and apparatus for performing video decoding in a multi-thread environment.

### BACKGROUND

Today, many computer systems are capable of supporting multi-threaded applications. These computer systems include single processor systems that perform simultaneous multithreading, multicore processor systems, and multiple processor systems. A program written as a multi-threaded application can perform a plurality of tasks in the program in parallel. This allows the program to run more efficiently than if it were written as a single-threaded application where tasks are performed sequentially.

In the past, programmers have attempted to write multi-threaded applications for video decoders. One approach taken by programmers was to decompose the data processed by the video decoder using slice-based dispatching. Slice-based dispatching involved dividing pictures in video bit streams into slices of macroblocks. Some decoders implemented static scheduling where threads were assigned pre-designated slices. Half-and-half dispatching is one example of static scheduling where a first thread is assigned a first plurality of slices which made up a first half of a frame, and a second thread is assigned a second plurality of slices which made up a second half of the frame. Other decoders implemented dynamic scheduling where threads were dynamically assigned slices. New slices were assigned to the threads when the threads finished processing previously assigned slices.

Data decomposition was effective for video decoders that processed earlier digital video compression formats. However, data decomposition has been less effective for more recent digital video compression formats due to the increasing number of dependencies between slices. The increasing number of dependencies found between slices has made it difficult to process slices independently. Attempts to force independence between slices at encode time resulted in reduced efficiency. Further, the large body of existing content that was not encoded using slicing would have to be re-encoded with slicing to benefit from the threading in a slicing-based decoder.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of an exemplary computer system in which an example embodiment of the present invention may be implemented.

FIG. 2A is a block diagram that illustrates a video decoder according to an example embodiment of the present invention.

FIG. 2B is a block diagram that illustrates a functional decomposition of the video decoder shown in FIG. 2A according to an example embodiment of the present invention.

FIG. 3 is a timing diagram that illustrates the operation of the embodiment of the video decoder shown in FIG. 2B according to an example embodiment of the present invention.

FIGS. 4A and 4B are flow charts illustrating a method for performing video decoding according to an example embodiment of the present invention.

FIG. 5A is a block diagram that illustrates a video decoder according to an alternate embodiment of the present invention.

FIG. 5B is a block diagram that illustrates a functional decomposition of the video decoder shown in FIG. 5A according to an example embodiment of the present invention

FIG. 5C is a block diagram that illustrates a functional decomposition of the video decoder shown in FIG. 5A according to an alternate embodiment of the present invention.

FIG. 6 is a timing diagram that illustrates the operation of the embodiment of the video decoder shown in FIG. 5B according to an example embodiment of the present invention.

FIGS. 7A and 7B are flow charts illustrating a method for performing video decoding according to a second embodiment of the present invention.

FIG. 8 is a timing diagram that illustrates the operation of the embodiment of the video decoder shown in FIG. 5C according to an example embodiment of the present invention.

FIGS. 9A-9C are flow charts illustrating a method for performing video decoding according to a third embodiment of the present invention.

### DETAILED DESCRIPTION

In the following description, for purposes of explanation, specific nomenclature is set forth to provide a thorough understanding of embodiments of the present invention. However, it will be apparent to one skilled in the art that specific details in the description may not be required to practice the embodiments of the present invention. In other instances, well-known components, programs, and procedures are shown in block diagram form to avoid obscuring embodiments of the present invention unnecessarily.

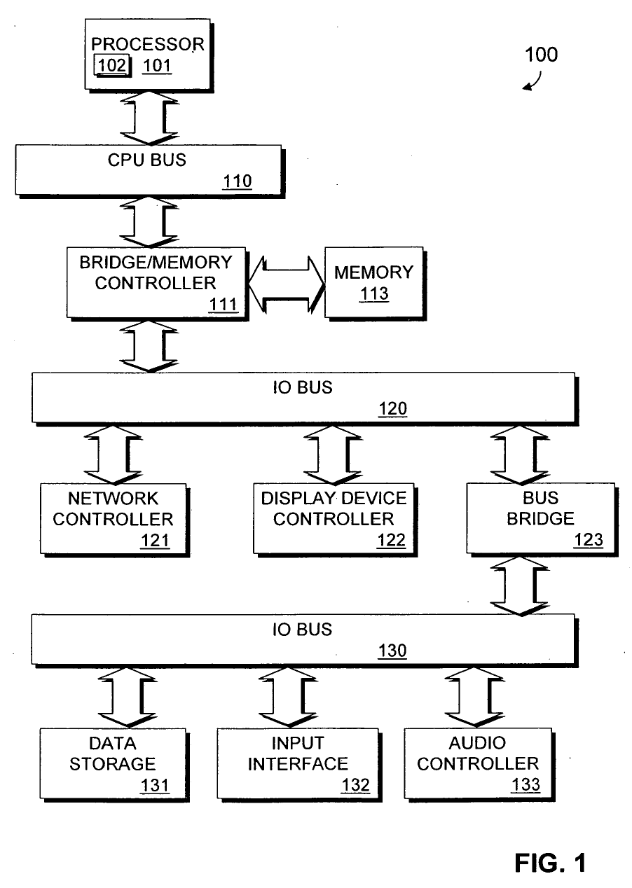

FIG. 1 is a block diagram of an exemplary computer system 100 according to an embodiment of the present invention. The computer system 100 includes a processor 101 that processes data signals and a memory 113. The processor 101 may be a complex instruction set computer microprocessor, a reduced instruction set computing microprocessor, a very long instruction word microprocessor, a processor implementing a combination of instruction sets, or other processor device. FIG. 1 shows the computer system 100 with a processor 101 capable of executing multiple threads. The processor 101 may be a single core processor that supports simultaneous multithreading (hyperthreading) or a multi-core processor with multiple processors on a chip. It should be appreciated, that the computer system 100 may also operate with multiple processors. The processor 101 is coupled to a CPU bus 110 that transmits data signals between processor 101 and other components in the computer system 100.

The memory 113 may be a dynamic random access memory device, a static random access memory device, read-only memory, and/or other memory device. The memory 113 may store instructions and code represented by data signals that may be executed by the processor 101.

According to an example embodiment of the present invention, the computer system 100 may implement a video decoder stored in the memory 113. The video decoder may be executed by the processor 101 in the computer system 100 to perform video decoding using multiple threads of execution. According to one embodiment, the tasks of the video decoder are functionally decomposed and assigned to a plurality of threads. The threads may at times be executed in parallel, allowing video decoding to be performed efficiently.

A cache memory 102 resides inside processor 101 that stores data signals stored in memory 113. The cache 102 speeds access to memory by the processor 101 by taking advantage of its locality of access. In an alternate embodiment of the computer system 100, the cache 102 resides external to the processor 101. A bridge memory controller 111 is coupled to the CPU bus 110 and the memory 113. The bridge memory controller 111 directs data signals between the processor 101, the memory 113, and other components in the computer system 100 and bridges the data signals between the CPU bus 110, the memory 113, and a first IO bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds and is also coupled to the IO bus 130. A bus bridge 123 couples the first IO bus 120 to the second IO bus 130. The bus bridge 123 operates to buffer and bridge data signals between the first IO bus 120 and the second IO bus 130.

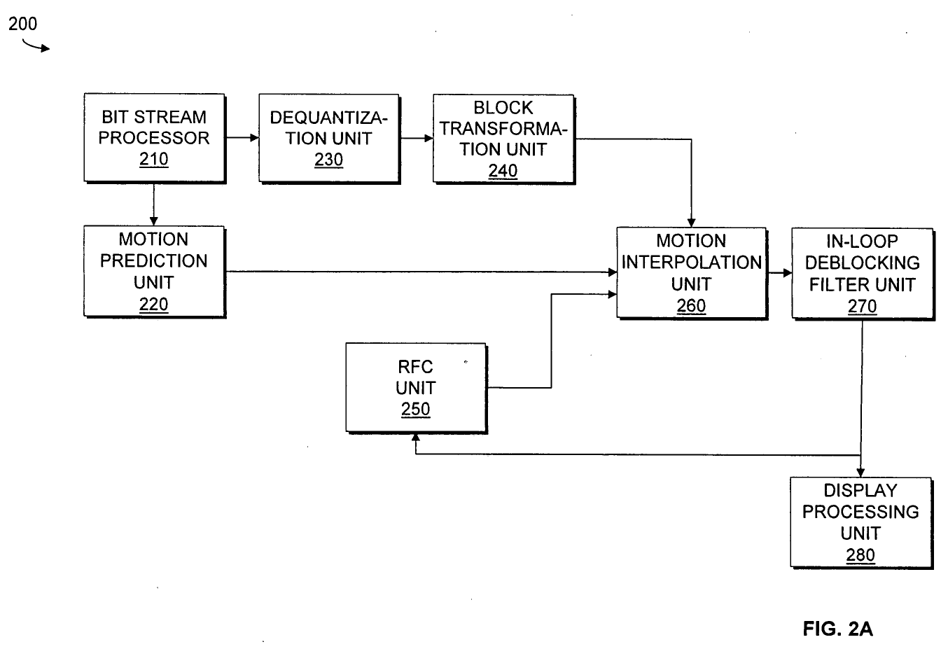

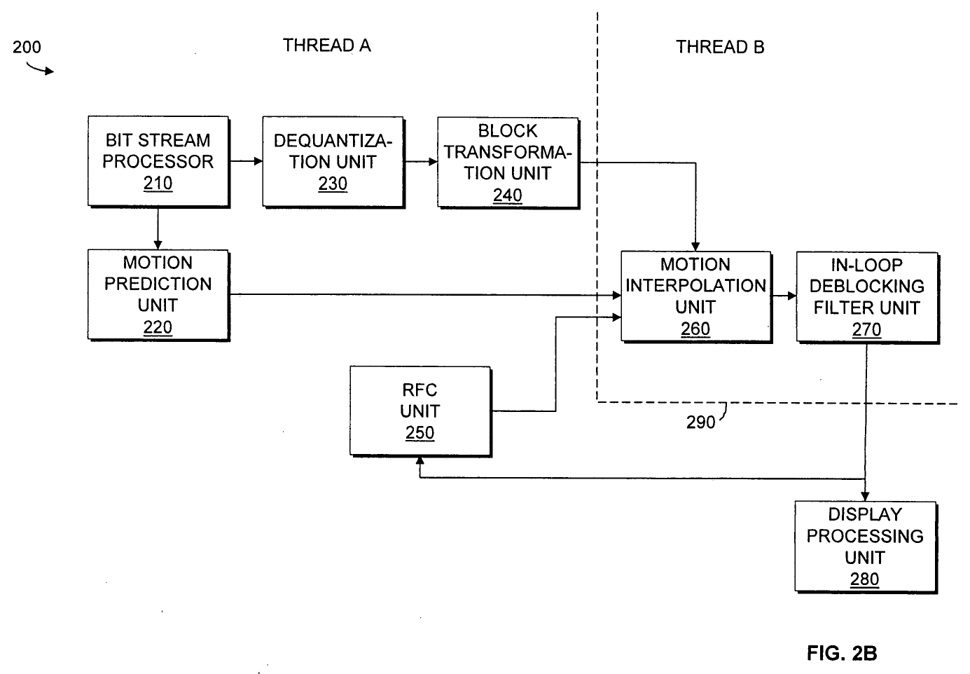

FIG. 2A is a block diagram that illustrates a video decoder 200 according to an example embodiment of the present invention. The video decoder 200 may be implemented on a computer system such as the one illustrated in FIG. 1. The video decoder 200 includes a bit stream processor 210. The bit stream processor 210 operates to parse and decode bit streams. According to an embodiment of the video decoder 200, the bit stream processor 210 performs entropy decoding on the bit streams. The bit stream processor 210 generates quantized error signals for inter/intra pixel data and pressed motion vectors for prediction errors.

The video decoder 200 includes a motion prediction unit 220. The motion prediction unit 220 processes the compressed motion vectors for prediction errors received from the bit stream processor 210 and historical data previously processed by the motion prediction unit 220 and generates motion vectors.

The video decoder 200 includes a dequantization unit 230. The dequantization unit 230 processes quantized error signals for inter/intra pixel data received from the bit stream processor 210 and generates dequantized inter/intra error signals.

The video decoder 200 includes a block transformation unit 240. The block transformation unit 240 performs a block transform on the dequantized inter/intra error signals received from the dequantization unit 230. The block transform unit 240 generates spatial domain pixels also known as pixel error values. According to an embodiment of the video decoder 200, the block transformation unit 240 performs an inverse discrete cosine transform.

The video decoder 200 includes a reference frame constructor (RFC) unit 250. The reference frame constructor unit 250 constructs a reference frame from data corresponding to previous frames processed by the video decoder 200. The reference frame is defined by a plurality of pixel values.

The video decoder 200 includes a motion interpolation unit 260. The motion interpolation unit 260 operates to interpolate pixel values from the motion vectors received from the motion prediction unit 220, pixel error values from the block transform unit 240, and the reference frame received from the reference frame constructor unit 250.

The video decoder 200 includes an in-loop deblocking filter unit 270. The in-loop deblocking filter unit 270 processes the pixel values received from the motion interpolation unit 260 and removes artifacts introduced by lossy aspects of an encoder. The output of the in-loop deblocking filter unit 270 is transmitted to and processed by the reference frame constructor unit 250.

The video decoder 200 includes a display processing unit 280. The display processing unit 280 processes the pixel values received from the in-loop deblocking filter unit 270. The display processing unit 280 may perform color conversion, de-interlacing, or other procedures on the pixel values. According to an embodiment of the video decoder 200, the display processing unit 280 may feed output frames to display hardware.

FIG. 2B is a block diagram that illustrates a functional decomposition of the video decoder 200 shown in FIG. 2A according to an embodiment of the present invention. Line 290 illustrates how video decoder 200 is decomposed. In this embodiment, a first thread, thread A, executes tasks performed by bit stream processor 210, motion prediction unit 220, dequantization unit 230, block transformation unit 240, reference frame constructor unit 250, and display processing unit 280. A second thread, thread B, executes tasks performed by motion interpolation unit 260 and in-loop deblocking filter unit 270. The output from the motion prediction unit 220, block transform unit 240, and reference frame constructor 250, from the first thread, is buffered for the second thread. The output from the in-loop deblocking filter unit 270, from the second thread, is buffered for the first thread.

The tasks performed by the dequantization unit 230 and/or the block transformation unit 240 may be assigned to either the first thread or the second thread. The assignment allows for the adjustment of the load between the first and second threads. In one embodiment, the adjustments may be made statically (e.g., based on representative performance measurements). In another embodiment, the adjustments may be made dynamically (e.g., based on runtime measurements of thread load balance).

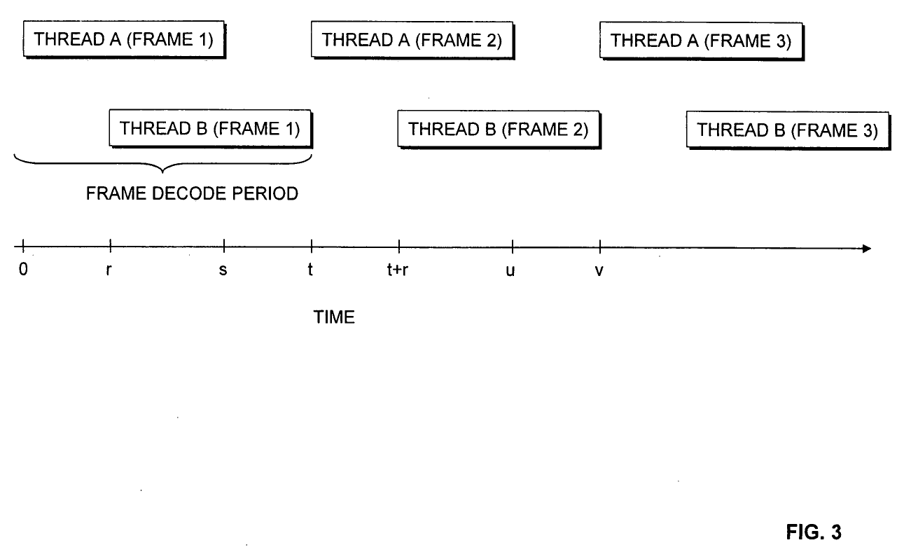

FIG. 3 is a timing diagram that illustrates the operation of the embodiment of the video decoder 200 shown in FIG. 2B according to an example embodiment of the present invention. At time 0, thread A is executed for processing a first frame (Frame 1). Thread B is not executed for processing the first frame until time i to allow thread A to process and buffer data in a queue to be used by thread B. At time r, thread B is executed for processing the first frame. From time r to time s, both threads A and B are executed in parallel for processing the first frame. At time t, thread A is executed for processing a second frame (Frame 2). Thread B is not executed for processing the second frame until time t+r to allow thread A to process and buffer data in a queue to be used by thread B. From time t+r to time u, both threads A and B are executed in parallel for processing the second frame.

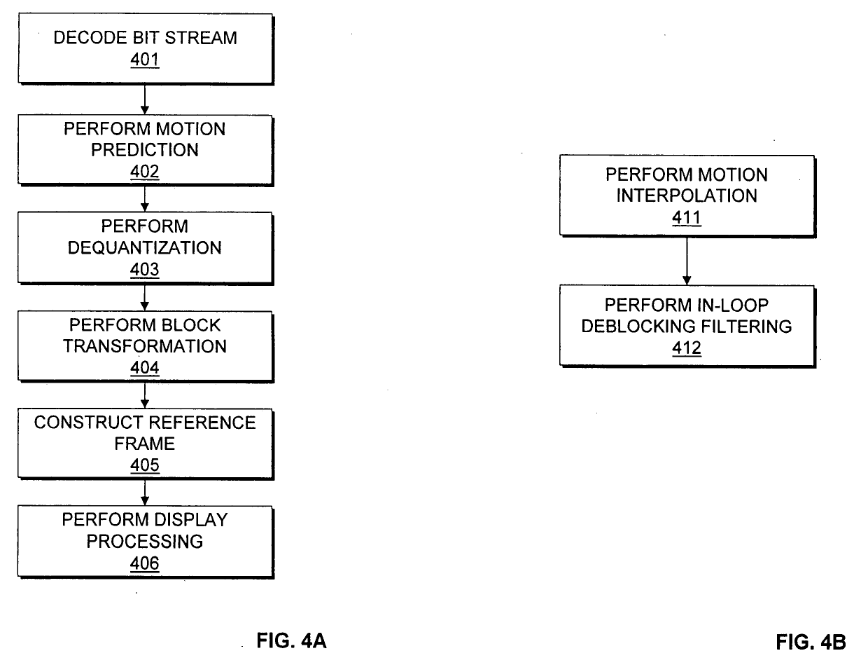

FIGS. 4A and 4B are flow charts illustrating a method for performing video decoding by a first and second thread according to an embodiment of the present invention. FIG. 4A illustrates a procedure performed by the first thread. At 401, a bit stream is decoded by a first thread. According to an embodiment of the present invention, entropy decoding is performed on the bit stream.

At 402, motion prediction is performed by the first thread. According to an embodiment of the present invention, motion vectors are generated from pressed motion vectors for prediction errors and historical motion vectors.

At 403, dequantization is performed by the first thread. According to an embodiment of the present invention, dequantized inter/intra error signals are generated from quantized error signals for inter/intra pixel data.

At 404, block transformation is performed by the first thread. According to an embodiment of the present invention, spatial domain pixels (pixel error values) are generated from dequantized inter/intra error signals.

At 405, construction of a reference frame is performed by the first thread. According to an embodiment of the present invention, a reference frame is generated from data corresponding to previous frames processed.

At 406, display processing is performed by the first thread. According to an embodiment of the present invention, display processing is performed after motion interpolation and loop deblocking is performed by a second thread. Display processing may include color conversion, de-interlacing, and/or other procedures.

FIG. 4B illustrate a procedure performed by the second thread. At 411, motion interpolation is performed by the second thread. According to an embodiment of the present invention, a frame is generated from the motion vectors, pixel error values, and the reference frame that are generated by the first thread.

At 412, in-loop deblocking is performed by the second thread. According to an embodiment of the present invention, artifacts are removed from the frame.

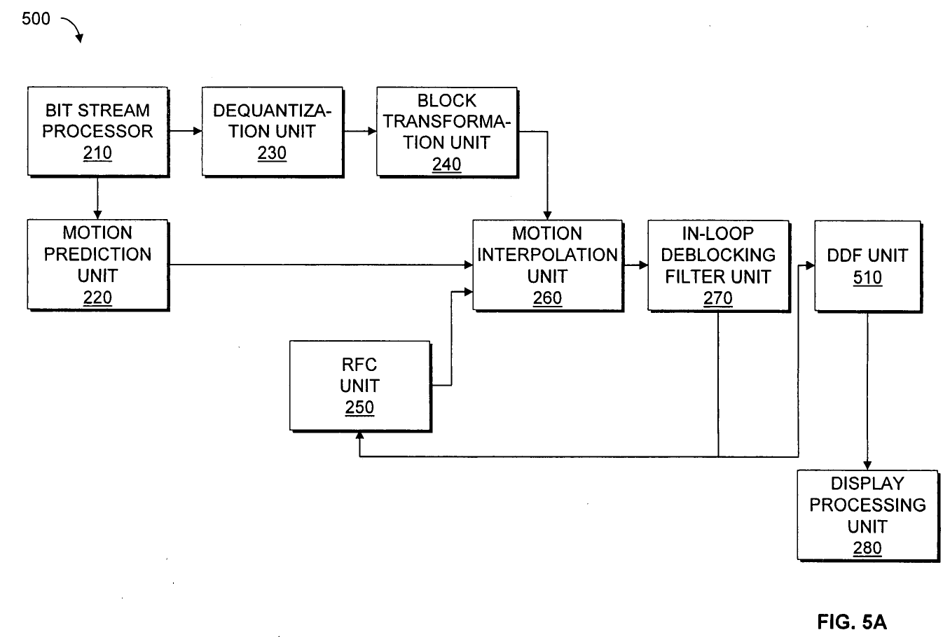

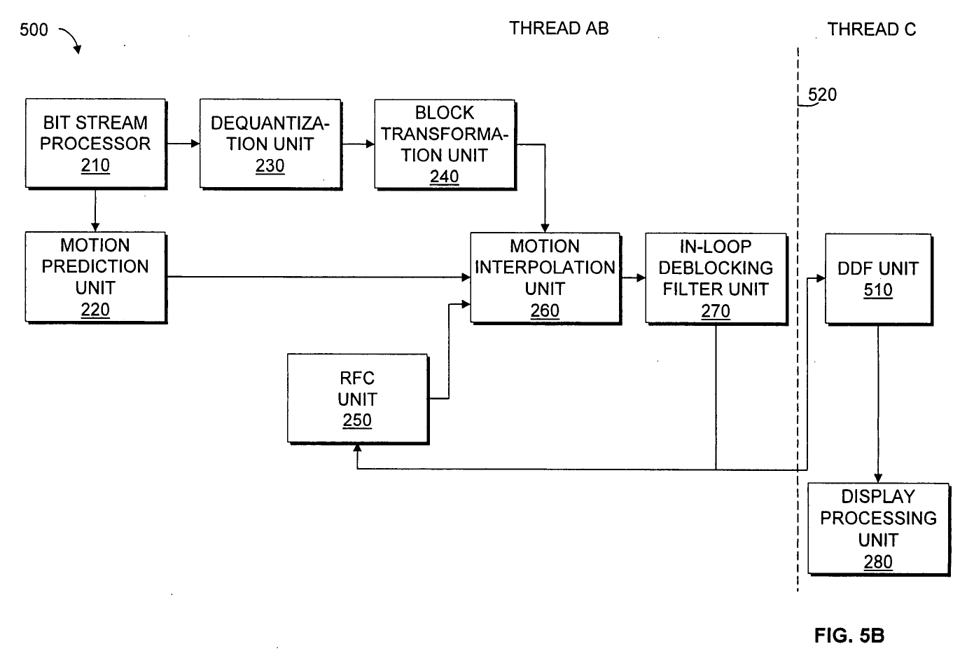

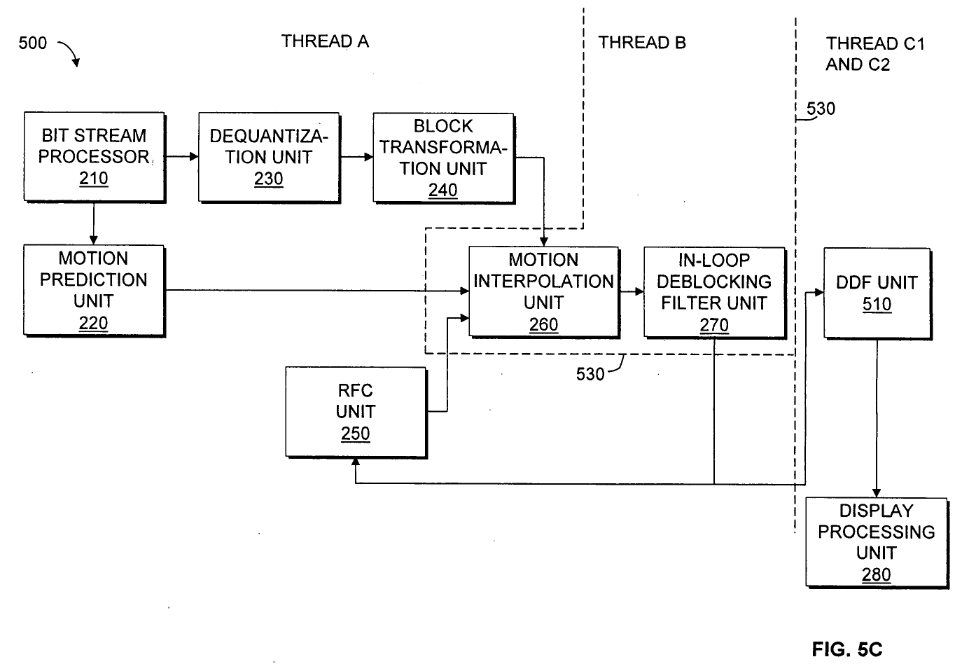

FIG. 5A is a block diagram that illustrates a video decoder 500 according to an alternate embodiment of the present invention. The video decoder 500 includes components that are found in video decoder 200. The video decoder 500 also includes a deblocking and deringing filter unit 510. According to an embodiment of the video decoder 500, the deblocking and deringing filter (DDF) unit 510 applies human visual system enhancement to an image to reduce visual severity of coding artifacts. The deblocking and deringing filter unit 510 operates out of a loop that transmits data back to the reference frame constructor unit 250.

FIG. 5B is a block diagram that illustrates a functional decomposition of the video decoder 500 shown in FIG. 5A according to an embodiment of the present invention. Line 520 illustrates how video decoder 500 is decomposed. In this embodiment, a first thread, thread AB, executes tasks performed by bit stream processor 210, motion prediction unit 220, dequantization unit 230, block transformation unit 240, reference frame constructor unit 250, motion interpolation unit 260, in-loop deblocking filter unit 270. A second thread, thread C, executes tasks performed by deblocking and deringing filter unit 510 and display processing unit 280. The output from the in-loop deblocking filter unit 270, from the first thread, is buffered for the second thread.

FIG. 5C is a block diagram that illustrates a functional decomposition of the video decoder shown in FIG. 5A according to an alternate embodiment of the present invention. Lines 530 illustrate how video decoder 500 is decomposed. In this embodiment, a first thread, thread A, executes tasks performed by bit stream processor 210, motion prediction unit 220, dequantization unit 230, block transformation unit 240, and reference frame constructor unit 250. A second thread, thread B, executes tasks performed by motion interpolation unit 260 and in-loop deblocking filter unit 270. One or more additional threads, C1 and C2, execute tasks performed by the deblocking and deringing filter unit 510 and the display processing unit 280. The output from the motion prediction unit 220, block transform unit 240, and reference frame constructor 250, from the first thread, is buffered for the second thread. The output from the in-loop deblocking filter unit 270, from the second thread, is buffered for the first thread and the one or more additional threads.

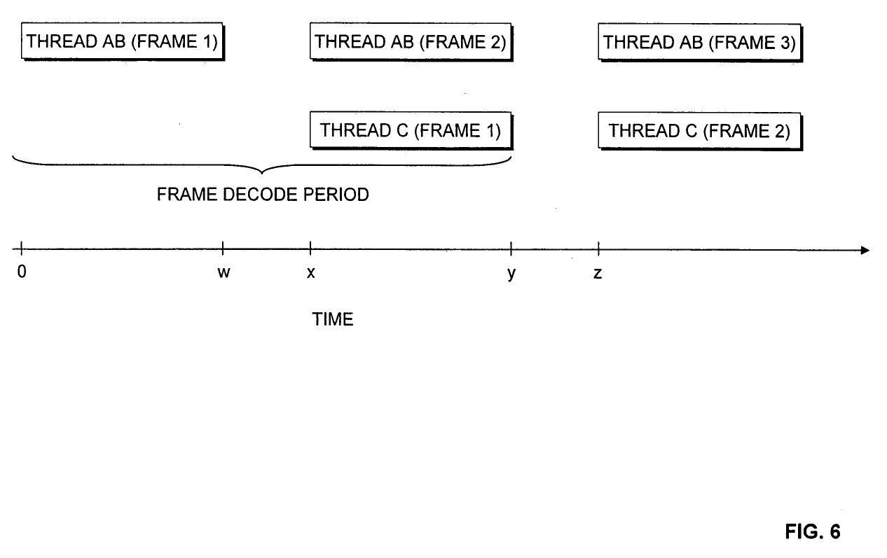

FIG. 6 is a timing diagram that illustrates the operation of the embodiment of the video decoder 500 shown in FIG. 5B according to an example embodiment of the present invention. At time 0, thread AB is executed for processing a first frame (Frame 1). Thread AB is executed for processing the first frame until time w. Thread C is not executed for processing the first frame until time x to allow thread AB to process and buffer data in a queue to be used by thread C. At time x, thread C is executed for processing the first frame and thread AB is executed for processing the second frame (Frame 2). From time x to time y, both threads AB and C are executed in parallel for processing different frames. At time z, thread AB is executed for processing a third frame (Frame 3) and thread C is executed for processing the second frame.

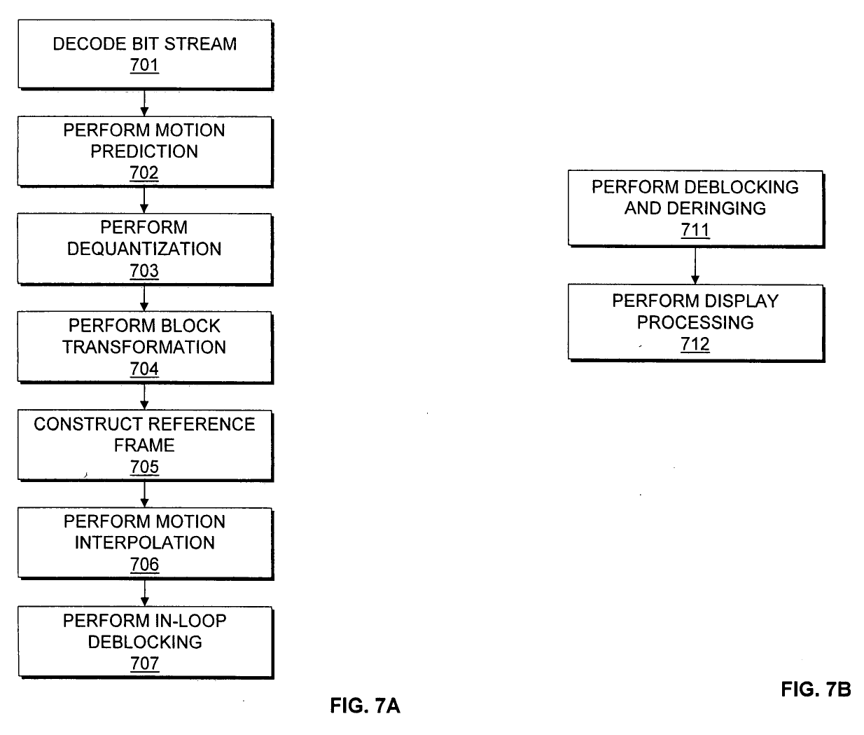

FIGS. 7A and 7B are flow charts illustrating a method for performing video decoding by a first and second thread according to a second embodiment of the present invention. FIG. 7A illustrates a procedure performed by the first thread. At 701, a bit stream is decoded by a first thread. According to an embodiment of the present invention, entropy decoding is performed on the bit stream.

At 702, motion prediction is performed by the first thread. According to an embodiment of the present invention, motion vectors are generated from pressed motion vectors for prediction errors and historical motion vectors.

At 703, dequantization is performed by the first thread. According to an embodiment of the present invention, dequantized inter/intra error signals are generated from quantized error signals for inter/intra pixel data.

At 704, block transformation is performed by the first thread. According to an embodiment of the present invention, spatial domain pixels (pixel error values) are generated from dequantized inter/intra error signals.

At 705, construction of a reference frame is performed by the first thread. According to an embodiment of the present invention, a reference frame is generated from data corresponding to previous frames processed.

At 706, motion interpolation is performed by the first thread. According to an embodiment of the present invention, a frame is generated from the motion vectors, pixel error values, and the reference frame.

At 707, in-loop deblocking is performed by the first thread. According to an embodiment of the present invention, artifacts are removed from the frame.

FIG. 7B illustrates a procedure performed by the second thread. At 711, deblocking and deringing is performed by the second thread. According to an embodiment of the present invention, human visual system enhancement is applied to an image to reduce visual severity of coding artifacts.

At 712, display processing is performed by the second thread. According to an embodiment of the present invention, display processing may include color conversion, de-interlacing, and/or other procedures.

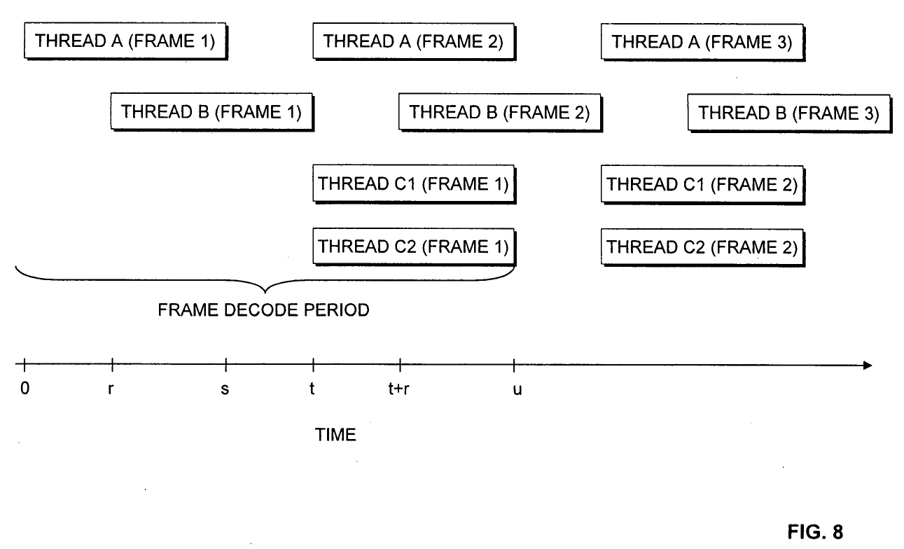

FIG. 8 is a timing diagram that illustrates the operation of the embodiment of the video decoder 500 shown in FIG. 5C according to an example embodiment of the present invention. At time 0, thread A is executed for processing a first frame (Frame 1). Thread B is not executed for processing frame 1 until time i to allow thread A to process and buffer data in a queue to be used by thread B. At time r, thread B is executed for processing the first frame. From time r to time s, both threads A and B are executed in parallel for processing the first frame. At time t, thread A is executed for processing a second frame (Frame 2) and threads C1 and C2 are executed for processing the first frame. Thread B is not executed for processing frame 2 until time t+r to allow thread A to process and buffer data for frame 2 in a queue to be used by thread B. From time t+r to time 1, both threads A and B are executed in parallel for processing the second frame, and threads C1 and C2 are executed for processing the first frame.

The timing diagrams shown in FIGS. 3, 6, and 8 illustrate only examples of how a video decoder practicing an embodiment of the present invention may operate. It should be appreciated that a video decoder practicing an embodiment of the present invention may operate differently. For example, FIG. 3 illustrates that at time t thread B has completed processing Frame 1, the first frame period has completed, and thread A has begun to process Frame 2. It should be appreciated that these three events, while typically occurring within some small interval of time around t, are not necessarily perfectly synchronized.

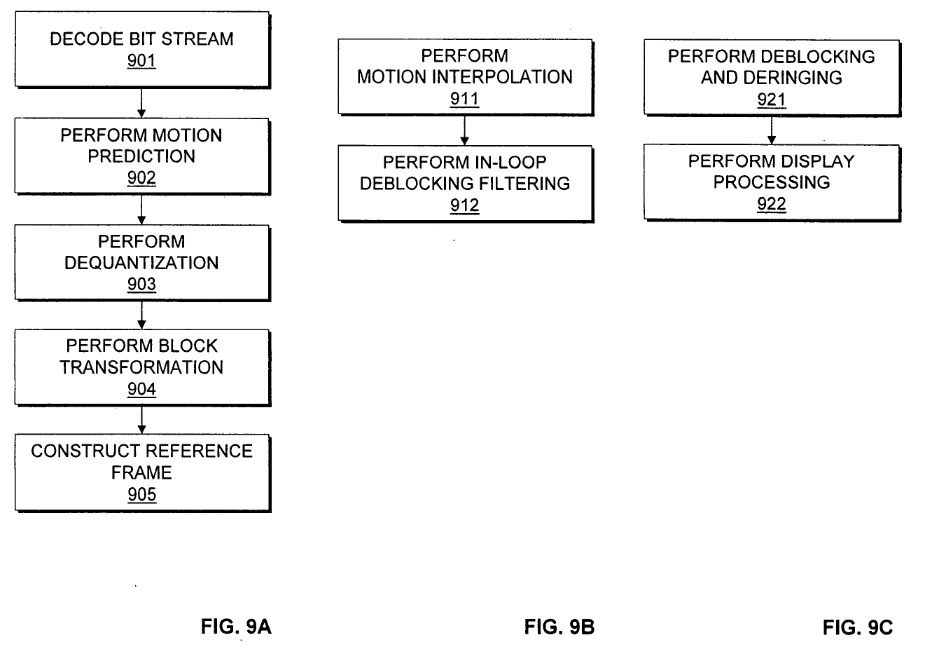

FIGS. 9A-C are flow charts illustrating a method for performing video decoding by a plurality of threads according to a third embodiment of the present invention. FIG. 9A illustrates a procedure performed by a first thread. At 901, a bit stream is decoded by a first thread. According to an embodiment of the present invention, entropy decoding is performed on the bit stream.

At 902, motion prediction is performed by the first thread. According to an embodiment of the present invention, motion vectors are generated from pressed motion vectors for prediction errors and historical motion vectors.

At 903, dequantization is performed by the first thread. According to an embodiment of the present invention, dequantized inter/intra error signals are generated from quantized error signals for inter/intra pixel data.

At 904, block transformation is performed by the first thread. According to an embodiment of the present invention, spatial domain pixels (pixel error values) are generated from dequantized inter/intra error signals.

At 905, construction of a reference frame is performed by the first thread. According to an embodiment of the present invention, a reference frame is generated from data corresponding to previous frames processed.

FIG. 9B illustrates a procedure performed by a second thread. At 911, motion interpolation is performed by the second thread. According to an embodiment of the present invention, a frame is generated from the motion vectors, pixel error values, and the reference frame that are generated by the first thread.

At 912, in-loop deblocking is performed by the second thread. According to an embodiment of the present invention, artifacts are removed from the frame.

FIG. 9C illustrates a procedure performed by one or more other threads. At 921, deblocking and deringing is performed by one or more other threads. According to an embodiment of the present invention, human visual system enhancement is applied to an image to reduce visual severity of coding artifacts.

At 922, display processing is performed by the one or more other threads. According to an embodiment of the present invention, display processing may include color conversion, de-interlacing, and/or other procedures.

FIGS. 2B, 5B, and 5C illustrate embodiments of the present invention where a video decoder is functionally decomposed to be implemented on separate threads. It should be appreciated that the video decoders illustrated in FIGS. 2B, 5B, and 5C may be further functionally decomposed such that additional threads may be implemented to perform the functions of the video decoders.

FIGS. 4A-B, 7A-B, and 9A-C are flow charts illustrating methods for performing video decoding according to exemplary embodiments of the present invention. Some of the procedures illustrated in the figures may be performed sequentially, in parallel or in an order other than that which is described. It should be appreciated that not all of the procedures described are required, that additional procedures may be added, and that some of the illustrated procedures may be substituted with other procedures.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

What is claimed is:

1. A method for performing video decoding, comprising:
executing a functionally decomposed video decoding procedure on a plurality of threads.

2. The method of claim 1, wherein executing the functionally decomposed video decoding on the plurality of threads, comprises:
performing motion prediction on a first thread; and
performing motion interpolation on a second thread.

3. The method of claim 2, further comprising performing block transformation on the first thread.

4. The method of claim 2, further comprising performing reference frame construction on the first thread.

5. The method of claim 2, further comprising performing in-loop deblocking on the second thread.

6. The method of claim 1, wherein performing the functionally decomposed video decoding on the plurality of threads, comprises:
performing in-loop deblocking on a first thread; and
performing out of loop deblocking and deringing on a second thread.

7. The method of claim 6, further comprising performing motion interpolation, and motion prediction on the first thread.

8. The method of claim 1, wherein executing the functionally decomposed video decoding on the plurality of threads, comprises:
performing motion prediction and block transformation on a first thread;
performing motion interpolation and in-loop deblocking on a second thread; and
performing out of loop deblocking and deringing on a third thread.

9. The method of claim 1, wherein executing the functionally decomposed video decoding on the plurality of threads, comprises:
performing motion prediction and block transformation on a first thread;
performing motion interpolation and in-loop deblocking on a second thread; and
performing out of loop deblocking and deringing on a third and fourth thread.

10. An article of manufacture comprising a machine accessible medium including sequences of instructions, the sequences of instructions including instructions which when executed cause the machine to perform:
executing a functionally decomposed video decoding procedure on a plurality of threads.

11. The article of manufacture of claim 10, wherein executing the functionally decomposed video decoding on the plurality of threads, comprises:
performing motion prediction on a first thread; and
performing motion interpolation on a second thread.

12. The article of manufacture of claim 11, further comprising instructions which when executed causes the machine to further perform performing block transformation on the first thread.

13. The article of manufacture of claim 10, wherein executing the functionally decomposed video decoding on the plurality of threads, comprises:
performing in-loop deblocking on a first thread; and
performing out of loop deblocking and deringing filtering on a second thread.

14. The article of manufacture of claim 10, wherein executing the functionally decomposed video decoding on the plurality of threads, comprises:
performing motion prediction and block transformation on a first thread;
performing motion interpolation and in-loop deblocking on a second thread; and
performing out of loop deblocking and deringing on a third thread.

15. The article of manufacture of claim 10, wherein executing the functionally decomposed video decoding on the plurality of threads, comprises:
performing motion prediction and block transformation on a first thread;
performing motion interpolation and in-loop deblocking on a second thread; and
performing out of loop deblocking and deringing on a third and fourth thread.

16. A computer system, comprising:
a memory; and
a processor implementing a video decoder to execute a functionally decomposed video decoding procedure on a plurality of threads.

17. The computer system of claim 16, wherein the video decoder comprises:
a motion prediction unit executed on a first thread; and
a motion interpolation unit executed on a second thread.

18. The computer system of claim 16, wherein the video decoder comprises:
an in-loop deblocking unit executed on a first thread; and
an deblocking and deringing unit on a second thread.

19. The computer system of claim 16, wherein the video decoder comprises:
a motion prediction unit executed on a first thread;
a block transformation unit on the first thread;
a motion interpolation unit executed on a second thread;
an in-loop deblocking unit executed on the second thread; and
a deblocking and deringing unit executed on a third thread.

20. The computer system of claim 16, wherein the video decoder comprises:
a motion prediction unit executed on a first thread;
a block transformation unit on the first thread;
a motion interpolation unit executed on a second thread;
an in-loop deblocking unit executed on the second thread; and
a deblocking and deringing unit executed on a third and fourth thread.
